(19) United States
(12) Patent Application Publication
(10) Pub. No.: US 2008/0187254 A1
(43) Pub. Date: Aug. 7, 2008

(54) HIGH CAPACITY LOBED PLASTIC BAGS

(75) Inventor: George M. Hall, Colleyville, TX (US)

Correspondence Address: AKIN GUMP STRAUSS HAUER & FELD, LLP, P O BOX 688, DALLAS, TX, 75313-0688, US

(73) Assignee: POLY-AMERICA, L.P., Grand Prairie, TX (US)

(21) Appl. No.: 11/672,009

(22) Filed: Feb. 6, 2007

(51) Int. Cl. B65D 33/16; B65D 30/02; B65F 1/06; B65F 1/00

(52) U.S. Cl. 383/77; 383/37

(57) ABSTRACT

The present invention is a high capacity lobed plastic bag with additional length for securely storing trash, debris and/or other materials produced from a polymeric tube. The polymeric tube defines the outer wall of the plastic bag with an upper end and a lower end. The lower end of the polymeric tube is sealed to form the bottom of the plastic bag. The upper end of the polymeric tube defines the opening of the plastic bag and features a curvilinear configuration. The bag according to the present invention overcomes the length and capacity constraints of the prior art and has a length greater than 41 inches from the bottom of the bag to a lowest point defined by the curvilinear configuration at the opening of the plastic bag. Thus, the plastic bag with a length greater than 41 inches has an increased capacity.

### CROSS-REFERENCE TO RELATED APPLICATIONS

Not applicable.

### STATEMENT REGARDING FEDERALLY SPONSORED RESEARCH OR DEVELOPMENT

Not applicable

### PARTIES TO A JOINT RESEARCH AGREEMENT

Not applicable.

### REFERENCE TO “SEQUENCE LISTING”

Not applicable.

### BACKGROUND OF THE INVENTION

1. Field of the Invention

The present application relates to plastic bags, particularly plastic bags featuring two or more lobes for securing the bag, the lobes extending upwardly from the opening of the bag.

2. Description of Related Art

Plastic bags are utilized throughout the world for refuse collection and disposal, storage, and other purposes. Plastic bags are generally manufactured by the blown-film extrusion process which includes forming a blown-film tube from polyethylene or other polymeric materials, flattening the blown-film tube, and then segregating the flattened tube into individual plastic bags by forming seals crossing transversely across the entire width of the tube. Smaller bags can be manufactured by introducing a combination of perforations and/or cuts extending transversely and/or longitudinally along the length of the polymeric tube. Larger bags can be manufactured by creating a line of perforations immediately below a transverse seal and repeating that process along the length of the blown-film tube. After formation of the bags, they are frequently folded axially one or more times and rolled into a fractional width roll.

The most common type of plastic bag is the standard bag featuring a straight-cut opening along the top of the bag. When securing the straight-cut type of plastic bag, a wire tie or other securing means may be utilized to secure the contents within the bag. Manufacture of large capacity straight-cut plastic bags requires a transverse seal and a perforation line immediately adjacent to the seal. The seal forms the bottom of a bag when the perforation is torn by an end-user. After tearing the perforation, the blown-film tube creates an open top that is essentially straight when the bag is laid flat. The side surfaces of the bag are essentially tubular, which results from the cylindrical shape of the blown-film tube.

When using plastic bags with straight-cut openings along the top of the bag, it is difficult to secure the bags after filling the bags to near full capacity. A natural disadvantage of the straight-cut bags is this difficulty in securing the bags when filled. Although it is possible to gather the ends of the bag together and tie the gathered ends to close the bag, this significantly reduces the capacity of the bag, resulting in less trash, debris and/or other materials contained within the bag.

In response to the need for a plastic bag that is easier to secure than standard plastic bags and that can be manufactured with essentially the same equipment used for manufacturing straight-cut bags, wave-cut bags have been introduced to the marketplace. However, prior to the present invention, wave-cut bags have been limited in length as measured from the bottom of the bag to the lowest concave valley of the waves at the top of the bag. Therefore, prior art bags were inherently limited in capacity to approximately 39 gallons. This is significant because, practically speaking, the only way to increase capacity on wave-cut bags, in any appreciable way, is to increase the length. The width of the wave-cut bag cannot be appreciably increased because it would then be impractical, given the distance from one side of the bag to the opposing side, to close an appreciably wider bag using the waves.

Small edge-type wave-cut bags can be produced by providing closely spaced, parallel transversely extending seals at predetermined intervals along the length of a flattened blown-film polymeric tube. A transversely extending line of perforations is provided between the closely spaced, parallel seals. The flattened blown-film polymeric tube is then separated longitudinally along a wave line located equidistant between the edges of the tube.

End-type wave-cut plastic bags are manufactured by providing sets of closely spaced, parallel transversely extending seals at predetermined intervals along the length of a flattened blown-film polymeric tube. A transversely extending line of perforations is provided between the closely spaced, parallel seals. A curvilinear perforation line is formed across the flattened blown-film tube at a location equidistant between successive sets of spaced, parallel seals. The result of manufacturing end-type wave-cut plastic bags is that between each seal, two wave-cut bags are created.

Using the manufacturing techniques and processes that were commercially available at the time of the present invention, the aforementioned wave-cut plastic bags were limited as to length and capacity because of the manufacturing equipment used to make such wave-cut bags (which was designed and is used to produce the straight-cut plastic bags). Straight-cut bags incorporate equipment limited to producing adjacent seals no more than 82 inches apart. When the wave-cut was applied to the straight-cut manufacturing process, the maximum size of the bags was essentially halved. Therefore, wave-cut bags in the prior art are manufactured on equipment which limits the length of the bags to no greater than 41 inches from the bottom of the bag to the lowest concave valley of the waves at the top of the bag. These limited lengths, in turn, result in wave-cut bags with limited capacities, which prior to the present invention have been capped at approximately 39 gallons.

By resigning prior art wave-cut bags to lengths of 41 inches or less, the prior art has lacked any teaching that wave-cut bags with longer lengths could be manufactured until the time of the present invention. Prior art wave-cut bags are produced on equipment designed and used to manufacture straight-cut bags, which results in wave-cut bag length and capacity being inherently limited. There also lacks any motivation in the prior art to carefully examine the manufacturing process and recognize the limitations of the prior art manufacturing processes that have, until the present invention, precluded the manufacture of wave-cut bags with lengths in excess of 41 inches. Despite a lack of any suggestion to modify the manufacturing process to enable longer wave-cut bags, there has been a long-felt need for wave-cut bags having additional length in excess of 41 inches and thus greater capacities. As realized with the present invention, the lobes at the top of the bag are particularly advantageous on longer, higher capacity plastic bags, which are generally more heavily loaded and especially difficult to close and tie. Thus, the present invention directly addresses that long-felt need.

### BRIEF SUMMARY OF THE INVENTION

The present invention overcomes the previously discussed limitations of wave-cut bags by recognizing and surmounting the limitations of the prior art manufacturing equipment and techniques. Further, the present invention is a direct result of the previously unrealized solution to increasing the length and thus the capacity of wave-cut plastic bags. Therefore, the heart of the present invention is a lobed plastic bag, with two or more lobes, having a length in excess of 41 inches from the bottom of the bag to the lowest concave valley of the waves at the top of the bag, and thus having additional capacity.

The present invention requires modifications to the manufacturing equipment used to produce the lobed plastic bags with additional lengths and thus additional capacity. Up until the present invention, despite over ten years of commercially available wave-cut plastic bags, there was no recognition that these modifications could be achieved. In fact, since prior art wave-cut plastic bags are manufactured on equipment designed and used to produce straight-cut bags, there has been a lack of motivation to make the equipment modifications resulting in the present invention. The present invention is made possible by modifying the manufacturing equipment such that seals may be separated by distances far exceeding that of the prior art manufacturing equipment. As described herein, a person having ordinary skill in the art will be enabled to practice the invention with little, if any, experimentation.

### BRIEF DESCRIPTION OF THE DRAWINGS

A full and complete understanding of the present invention may be obtained by reference to the detailed description of the invention when viewed with reference the accompanying drawings. The drawings can be briefly described as follows:

FIG. 1A is a profile view of a straight-cut plastic bag when manufactured from a flattened, blown-film polymeric tube as is known in the prior art.

FIG. 1B provides a perspective view of the large-capacity straight cut plastic bag as known in the prior art when partially filled with trash, debris and/or other materials.

FIG. 2 is a profile view of a flattened, blown-film polymeric tube when prepared in accordance with the present invention, showing an “opposing” or “end-type” lobed plastic bag.

FIG. 3 is a perspective view of a partially filled lobed plastic bag that has additional length, as measured from the bottom of the bag to the lowest concave valley of the waves at the top of the bag, thus providing additional capacity, and which is manufactured from the flattened, blown-film polymeric tube, according to one embodiment of the present invention.

### DETAILED DESCRIPTION OF THE INVENTION

The present disclosure illustrates embodiments of the present invention. In view of the disclosure of the invention contained herein, a person having ordinary skill in the art will recognize that innumerable modifications and insubstantial changes may be incorporated or otherwise included within the present invention without diverging from the spirit of the invention. Therefore, it is understood that the present invention is not limited to those embodiments disclosed herein. Furthermore, the appended claims are intended to encompass the invention to the fullest extent possible, but it is fully appreciated that limitations on the use of particular terms is not intended to conclusively limit the scope of protection for a particular application.

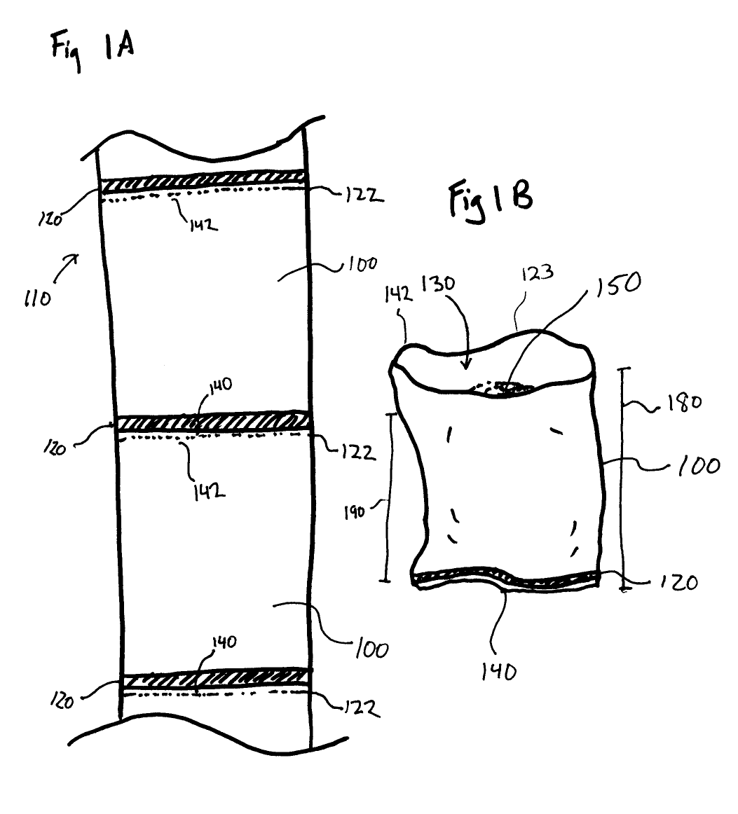

Referring now to FIG. 1A, an illustration of the straight-top plastic bag is provided. As can be seen with respect to FIG. 1A, the straight-cut plastic bags 100 are manufactured from a blown-film polymeric tube 110. For simplicity, FIG. 1A depicts only a portion of the blown-film polymeric tube 110, which can be introduced to the manufacturing process as a coil or directly introduced from the blown-film extrusion process. The extruded blown-film polymeric tube 110 is flattened to allow the manufacturing equipment to cut and seal the upper and lower surfaces of the flattened blown-film polymeric tube 110. In some embodiments, the blown-film polymeric tube 110 may be folded during the manufacturing process, as is known in the prior art. In some embodiments, seals 120 and perforation lines 122 may be introduced before or after the folding operation. A person having ordinary skill in the art will recognize the numerous different configurations for the manufacture of the straight-cut bag 100 as known in the prior art.

The first end 140 of the straight-cut plastic bag 100 is defined by a seal 120 extending transversely across the flattened, blown-film polymeric tube 110. Seals 120 are generally formed by positioning a heated bar on at least one side and an associated anvil (both not shown) on the opposite side of the flattened, blown-film polymeric tube 110. The heated bar engages the flattened, blown-film polymeric tube 110 at a threshold pressure, softening the blown-film polymeric tube 110 forming a permanent bond between the two sides of the flattened blown-film polymeric tube 110.

The second end 142 of the straight-cut plastic bag 100 is defined by a perforation line 122 extending transversely across the flattened, blown-film polymeric tube 110 and located immediately adjacent to the seal 120 as shown. Perforation lines 122 may be formed by positioning a tooth bar and associated anvil (both not shown) on opposing sides of the flattened, blown-film polymeric tube 110. When the tooth bar and associated anvil are brought together a perforation line 122 is formed. A person having skill in the art would instantly recognize that other techniques may be appropriately substituted to create similar seals 120 and perforation lines 122.

The perforation lines 122 are typically not fully cut at the time of manufacture, or at any time before the sale of the product, to allow multiple straight-cut plastic bags 100 to be rolled together. After procuring straight-cut plastic bags 100, the end-user may tear off a single straight-cut plastic bag 100 from the roll as needed. Further, to minimize the space required for storage and sale of the straight-cut plastic bags 100, the flattened blown-film polymeric tube 110 may be folded one or more times longitudinally before forming the roll of straight-cut plastic bags 110.

FIG. 1B provides a perspective view of the straight-cut plastic bag 100 partially filled with material 150, after separating an individual straight cut plastic bag 100. This particular straight-cut plastic bag 100 has a length 180 generally defined by the distance between the seal 120 at the first end 140 of the straight-cut plastic bag 100 and the torn perforation line 123 which defines the upper opening 130 at the second end 142 of the straight-cut plastic bag 100. However, in practice, the functional length 190 of the straight-cut trash bag 100 is considerably reduced to allow for the second end 142 of the straight-cut bag 100 to be collected and fastened together, thereby securing the material 150 within the straight-cut plastic bag 100. Further, prior art straight-cut plastic bags 100 require additional means to assist in securing the upper opening 130 of the straight-cut plastic bag 100 as the essentially straight aspect of the opening 130 makes it difficult to securely close without using excessive amounts of the walls of the straight-cut plastic bag 100.

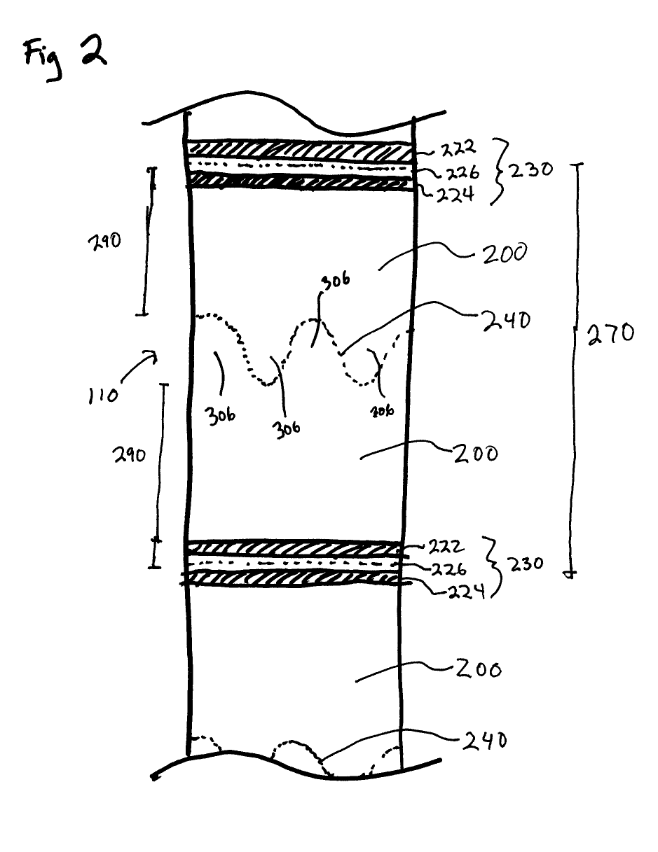

Referring now to FIG. 2, an illustration of the lobed plastic bag 200 as manufactured according to the present invention is presented. A flattened, blown-film polymeric tube 110 is depicted as used in manufacture of the straight-cut plastic bags 100. However, rather than seal/perforation pairs as used in the manufacture of straight-cut plastic bags or prior art wave-cut bags, the flattened, blown-film polymeric tube 110 has a first transverse seal 222 and a second transverse seal 224 parallel and in close proximity to the first transverse seal 222. Between the first transverse seal 222 and the second transverse seal 224 is a straight perforation line 226 that defines the first end 142 of two adjacent lobed plastic bags 200. This combination of the first transverse seal 222, the second transverse seal 224, and the straight perforation line 226 may be referred to collectively as a seal/perforation zone 230.

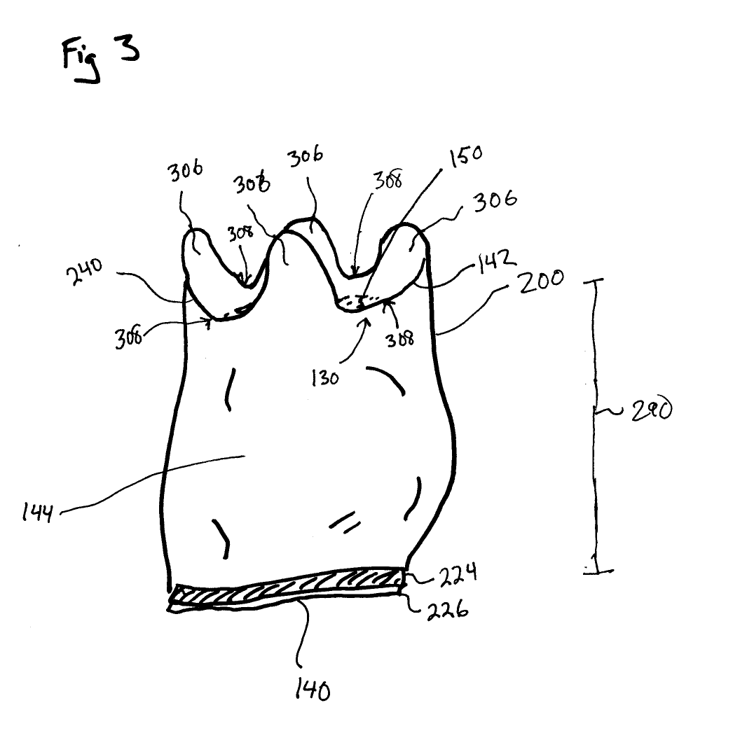

At a point approximately equidistant from two consecutive seal/perforation zones 230, a curvilinear perforation line 240 is formed across the flattened blown-film polymeric tube 110. The curvilinear perforation line 240 results in the lobed plastic bag 200 having a lobe-shaped configuration at a second end 142. This configuration will be more fully described in reference to FIG. 3. The curvilinear perforation line 240 creates a wave-like line that results in a curvilinear configuration with at least two, and preferably four, lobes 306 to be tied for the closure system.

The curvilinear perforation line 240 can be formed by positioning a star wheel (not shown) having a toothed outer edge and an anvil wheel (not shown) with a substantially flat or recessed outer edge on opposing sides of the flattened, blown-film polymeric tube 210. When force is applied to the star wheel and anvil wheel, the curvilinear perforation line 240 is formed into the flattened, blown-film polymeric tube 110. Although FIG. 2 depicts a curvilinear perforation line 240 it is contemplated by the invention that by introducing one or more longitudinal folds into the flattened, blown-film polymeric tube 110 a plurality of alternative perforated patterns including, but not limited to, V-shaped or S-shaped perforation lines may be made to produce the desired number of lobes to be tied for the closure system. A person having ordinary skill in the art will recognize that other alternative techniques may be used to create the curvilinear perforation lines 240 and the resulting lobes.

The lobed bag 200 of the present invention overcomes the size limitations and capacity constraints of the wave-cut bags of the prior art. In particular, the length 290 of the lobed bag of the present invention is greater than 41 inches from the bottom of the bag to the top of the lowest concave valley of the waves at the top of the bag. The length 290 of greater than 41 inches ensures greater capacity of the lobed bag 200 according to the present invention. In order to make two equally sized bags with lengths 290 of greater than 41 inches, the spacing 270 between consecutive seal/perforation zones 230 can be no less than 82 inches.

Referring now to FIG. 3, a perspective view of the lobed plastic bag 200 is depicted to better illustrate the longer and enhanced capacity of the lobed plastic bag 200 of the present invention. The blown-film, polymeric tube 110 forms a substantially cylindrical outer wall 144 of the lobed plastic bag. A transverse seal 224 and the closely positioned straight perforation line 226 result in a sealed first end 140, of the lobed plastic bag 200. The second end 142 of the lobed plastic bag 200 is defined by the curvilinear perforation line 240, such as a lobe-shaped configuration as shown. The lobe-shaped configuration results in lobes 306, used for closure, and concave valleys 308 between lobes 306. The distance from each concave valley of the lobed closure system 308 to the first end 226 of the bottom of the lobed plastic bag 200, exceeds 41 inches, resulting in a greater overall capacity for the lobed plastic bag 200 made according to the present invention. When opposing lobes 306 are tied to one another, the lobed plastic bag 200 will securely hold its contents for transportation, storage, and/or disposal.

Although preferred embodiments of the present invention have been illustrated in the accompanying Figures and described within this written description, it will be understood that the invention is not limited to the embodiments disclosed herein, but is capable of other rearrangements, modifications, and substitutes of parts and elements without departing from the spirit of the invention.

The claimed invention is:

1. A plastic bag for securely storing trash, debris and/or other materials comprising:
a polymeric tube defining an outer wall of the plastic bag, the polymeric tube having an upper end and a lower end,
wherein the lower end of the polymeric tube is sealed and defines a bottom of the plastic bag, and wherein the upper end of the polymeric tube defines an opening of the plastic bag,
wherein the opening of the plastic bag defines a curvilinear configuration,
wherein the plastic bag has a length defined by a distance from the bottom of the bag to a lowest point defined by the curvilinear configuration of the opening, and
wherein the length of the plastic bag is greater than 41 inches.

2. The plastic bag of claim 1 wherein the curvilinear configuration of the opening defines at least two lobes and at least two concave valleys, wherein the lowest point is defined by the at least two concave valleys.

3. The plastic bag of claim 1 wherein the curvilinear configuration of the opening is lobe-shaped.

4. The plastic bag of claim 2 wherein the at least two lobes are integrally formed with the polymeric tube.

5. The plastic bag of claim 1 wherein the outer wall of the plastic bag is substantially cylindrical.

6. The plastic bag of claim 1 wherein the polymeric tube is a blown-film polymeric tube.

7. The plastic bag of claim 1 wherein the bottom of the plastic bag is sealed with a heat-formed seal.

8. A plastic bag comprising:
at least two panels wherein each panel defines a top edge, a bottom edge, a first side edge and a second side edge,
wherein the at least two panels are interconnected by connecting the first side edge of a panel to the second edge of an adjacent panel to form a substantially hollow configuration,
wherein the top edges of the at least two panels define an upper end of the plastic bag, the upper end of the plastic bag defining a curvilinear configuration,
wherein the bottom edges of the at least two panels are connected to form a sealed bottom of the plastic bag, and
wherein a length of the plastic bag is greater than 41 inches, the length being measured from the sealed bottom of the plastic bag to a lowest concave valley of the curvilinear configuration defined by the upper end of the plastic bag.

9. The plastic bag of claim 8,
wherein the at least two panels are interconnected by being integrally formed.

10. The plastic bag of claim 8,
wherein the at least two panels are interconnected by sealing the respective first and second side edges.

11. The plastic bag of claim 8,
wherein the curvilinear configuration defined by the upper end defines a series of at least two lobes and at least two concave valleys located between adjacent lobes.

12. A connected series of plastic bags comprising:
a polymeric tube,
wherein the polymeric tube has a plurality of seal/perforation zones, wherein each seal/perforation zone is comprised of a pair of parallel seals extending transversely across the polymeric tube and a straight perforation line extending transversely across the polymeric tube, wherein the straight perforation line is disposed between the pair of parallel seals,
wherein a curvilinear perforation line extends transversely across the polymeric tube at a location between two adjacent seal/perforation zones, and
wherein a distance between two adjacent seal/perforation zones is greater than 82 inches.

13. The connected series of lobed plastic bags of claim 12, wherein the curvilinear perforation line has a lobe-shaped configuration.

14. The connected series of plastic bags of claim 12, wherein the location between two adjacent seal/perforation zones where the curvilinear perforation line extends transversely across the polymeric tube is substantially equidistant from each of the adjacent seal/perforation zones.

15. The connected series of plastic bags of claim 12, wherein the polymeric tube is folded at least once longitudinally.
